(19) United States
(12) Patent Application Publication
(10) Pub. No.: US 2013/0247027 A1
(43) Pub. Date: Sep. 19, 2013

(54) Distribution and installation of solidified software on a computer

(71) Applicants: Bakul Shah, Los Altos, CA (US); Rishi Bhargava, San Jose, CA (US); E. John Sebes, Menlo Park, CA (US)

(72) Inventors: Bakul Shah, Los Altos, CA (US); Rishi Bhargava, San Jose, CA (US); E. John Sebes, Menlo Park, CA (US)

(73) Assignee: SolidCore Systems, Inc., Palo Alto, CA (US)

(21) Appl. No.: 11/060,683

(22) Filed: Feb. 16, 2005

(51) Int. Cl. G06F 9/445

(52) U.S. Cl. CPC G06F 8/61
USPC 717/177; 717/174

(57) ABSTRACT

Techniques relating to the distribution and installation of solidified (or “frozen”) software on a computer are disclosed. Any additional software installed on the computer after the solidification process will not execute, regardless of whether the installation is initiated or otherwise performed by a person with administrative privilege. The installation of the solidified software can be carried out by installing pre-solidified software, by solidifying the software at the source code level and by solidifying the software by the compiler. The solidification can also be performed when software distributions are manufactured, for example on CDs, or as part of an installation procedure that can run and/or install differently each time. A business process for billing customers for the transfer or usage of solidified software is also disclosed.

### BACKGROUND

1. Field

Invention relates generally to computer systems, and in particular to the distribution and installation of solidified software in order to maintain the integrity of software and computer systems.

2. Related Art

The set of software available for execution on a computer is generally dynamic and modifiable, even when such modification is not desirable. Restricting the ability of users or administrators of a computer to install and remove software or to modify configuration of the existing software is enforced with passwords or verbal and written policies and guidelines. However, when passwords are used, possessors of administrative passwords generally have access beyond their immediate responsibilities.

Accordingly, there is a need for a technique for distributing and installing solidified (or “frozen”) software for maintaining the integrity of software and computer systems.

### SUMMARY

Technology for distributing and installing solidified (or “frozen”) software for maintaining the integrity of software and computer systems is disclosed. Solidified software has the characteristic that any additional software installed on the computer after the solidification process will not execute, regardless of whether the installation is initiated or otherwise performed by a person with administrative privilege. The installation of the solidified software can be carried out by installing pre-solidified software, by solidifying the software at the source code level and by solidifying the software by the compiler. The solidification can also be performed when software distributions are manufactured, for example on CDs, or as part of an installation procedure that can run and/or install differently each time. A business process for billing customers for the transfer or usage of solidified software is also disclosed.

### BRIEF DESCRIPTION OF DRAWINGS

FIG. 1 is a block diagram illustrating the life cycle modes of an architecture for solidifying an executable software set of a computer, according to an embodiment of the present invention.

FIG. 2 is a flow chart illustrating a method for installing pre-solidified software, according to an embodiment of the present invention.

FIG. 3 is a flow chart illustrating solidification at the source code level, according to an embodiment of the present invention.

FIG. 4 is a block diagram illustrating a compiler used for solidification, according to an embodiment of the present invention.

FIG. 5 is a flow chart illustrating a manufacturing method for producing one or more storage media devices, according to an embodiment of the present invention.

FIG. 6 is a flow chart illustrating a method for performing solidification as part of an installation procedure, according to an embodiment of the present invention.

FIG. 7 is a diagram illustrating a business method for distributing solidified software, according to an embodiment of the present invention.

### DETAILED DESCRIPTION

The following serves as a glossary of terms as used herein:

Computer: Any computing system comprising an operating system providing a set of resources for use by one or more pieces of software for execution on the computing system.

Interface: A language, protocol or other boundary for providing a service or making available a resource to a piece of software on a computer. An interface comprises a name space, knowledge of which is needed for successful usage of the interface. For a given interface to a service or resource, an implementation of the service or resource fulfills requests made through the interface. One example of an interface comprises an Application Programming Interface (API) such as a system call interface of an operating system, wherein the name space comprises system call names or system call addresses, and the implementation comprises the portion of the operating system implementing the actual system calls. Another example of an interface comprises a set of function calls to a library, wherein the name space comprises function names or function addresses, and the implementation comprises the actual library code implementing the functions. Other interface examples include language APIs (such as a PERL API, Java API, PHP API, shell script APIs, etc.), database APIs, an interface to a file system of a computer (wherein the name space comprises a set of file names), and any interface to a container of data.

Software: Any set of instructions for execution on a computer. A piece of software may use one or more services or resources as provided by the computer through one or more interfaces.

Solidification: Creation of a unique computing system by converting uniform systems into functionally equivalent but logically unique systems, generally by breaking assumptions about a computer that software programs normally make in order to execute on that computer. In one example of solidification, the ability of unknown code to use common APIs is removed, thereby rendering the unknown code un-executable on a solidified system. This ensures that only authorized code retains its ability to use system services, via APIs that are both unique to each computer system, and also transparent to the authorized code on the computer system.

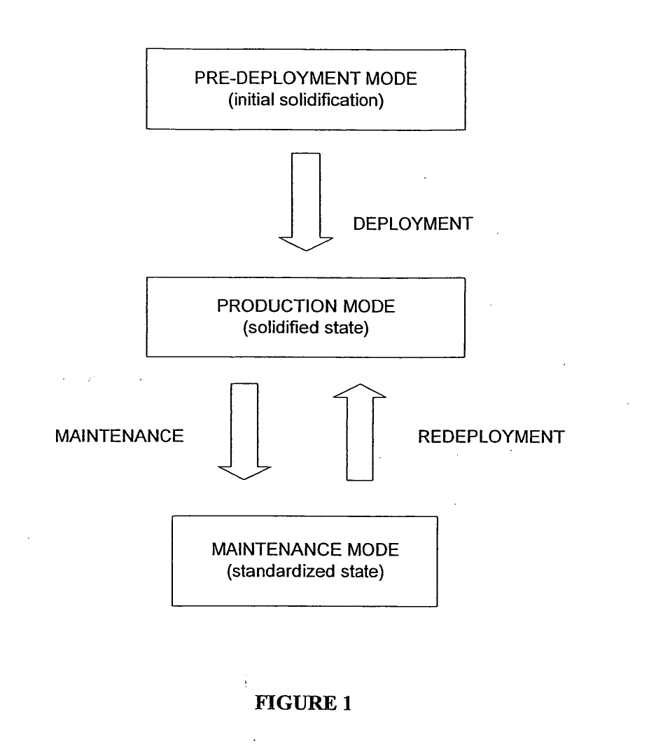

FIG. 1 is a block diagram illustrating the life cycle modes of an architecture for solidifying an executable software set of a computer, according to an embodiment of the present invention. An example solidification approach is described in co-pending U.S. patent application titled, “Damage Containment by Translation”, Ser. No. 10/651,588, filed on Aug. 29, 2003, assigned to the assignee of the present application, and incorporated herein by reference. This example solidification approach is applicable to the embodiments described below.

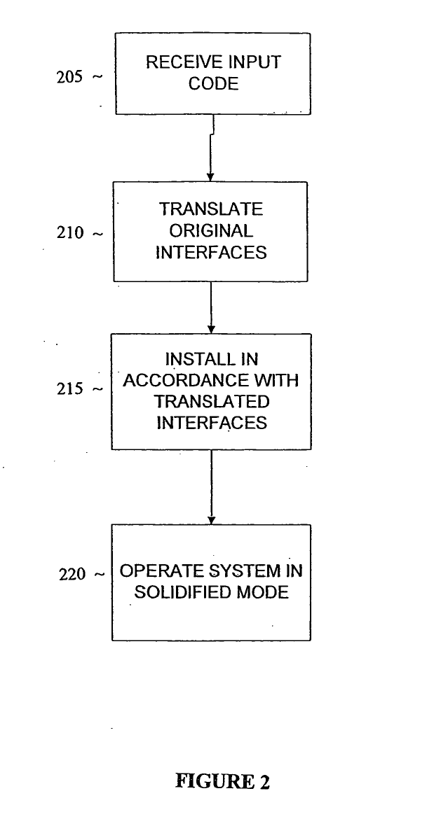

FIG. 2 is a flow chart illustrating a method for installing pre-solidified software, according to an embodiment of the present invention. The method for installing software comprises the steps of receiving input code having an original interface, translating the original interface in accordance with a set of placeholder attributes and installing the input code in accordance with the translated interface. The method can further comprise the step of using the translated interface to operate the system in a solidified mode.

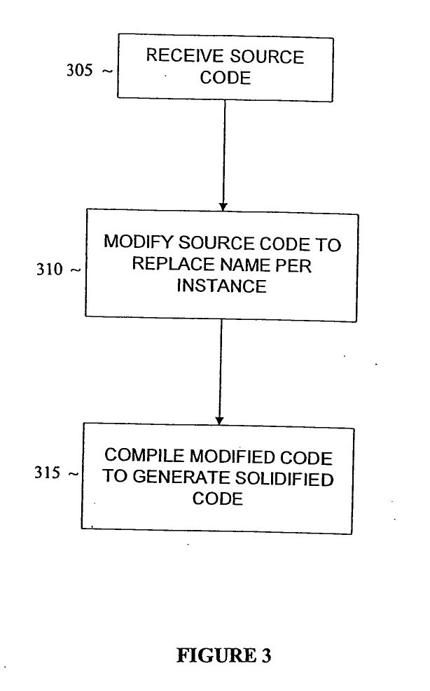

FIG. 3 is a flow chart illustrating solidification at the source code level, according to an embodiment of the present invention. Solidification at the source code level can be carried out through a method for creating a translation gateway through an application interface, comprising the steps of receiving source code, and modifying the source code to replace one or more instance names. The step of modifying the source code to replace one or more instance names can include replacing one or more API parameters. The modified source code can be licensed under a new set of licensing terms. The method can further comprising modifying the source code for usage under a revised set of licensing terms.

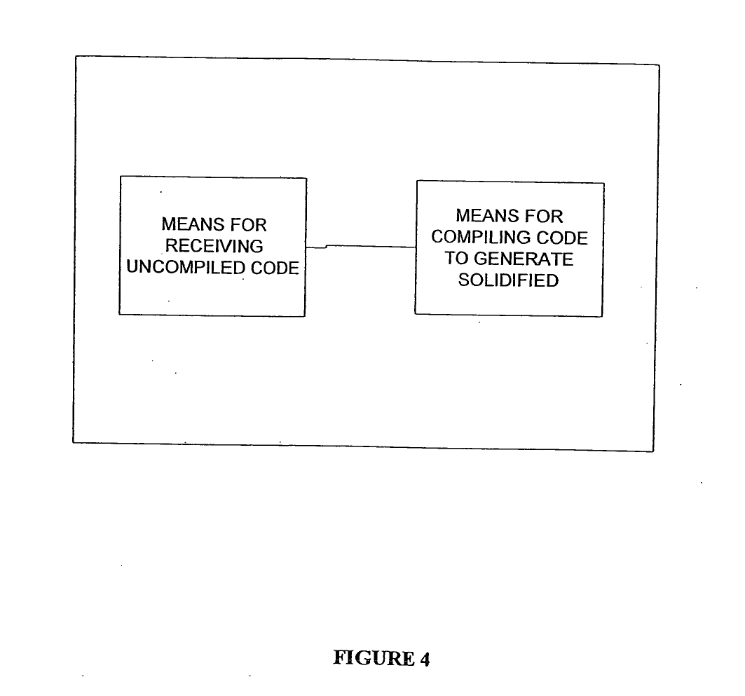

FIG. 4 is a block diagram illustrating a compiler used for solidification, according to an embodiment of the present invention. An apparatus for compiling software comprises means for receiving uncompiled source code, and means for compiling the uncompiled source code to generate solidified code wherein the uncompiled source code does not include specific coding attributes relating to solidification.

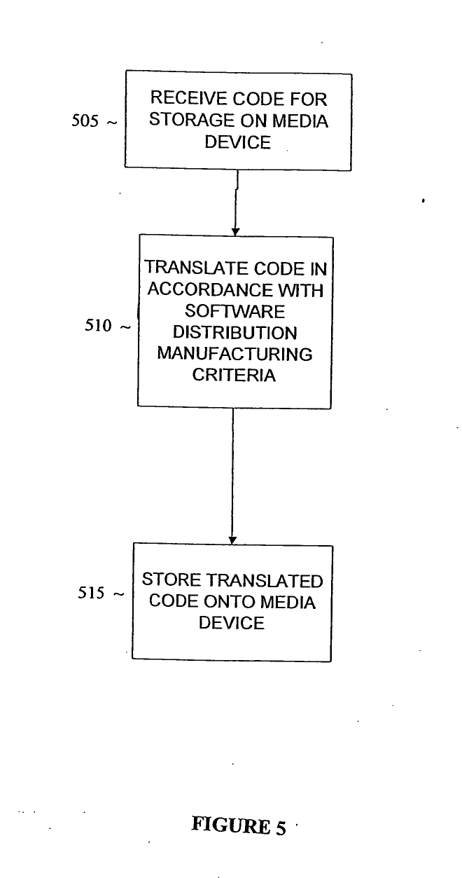

FIG. 5 is a flow chart illustrating a manufacturing method for producing one or more storage media devices, according to an embodiment of the present invention. The manufacturing method can comprise the steps of receiving input code for storage on a media device, wherein the input code has an original interface, and producing a media device comprising translating the original interface in accordance with a set of placeholders, and copying the translated code to the media device in accordance with predetermined manufacturing criteria. The placeholders indicate that a reference name at a given position in the input code, taken from an interface name space, is to be replaced with a corresponding translated name in a corresponding translated name space. The predetermined manufacturing criteria include criteria relating to how each particular storage media can be different, for example, if each storage media is to have a unique identification number for tracking the license of the software. The storage media device that is produced in this manner includes solidified code. The storage media can be a primary storage device for a processor, where the solidified code is stored in this storage device, such that the computer comprising the processor and the storage device is built with solidified code. The manufacturing method can further include licensing usage of the produced storage media.

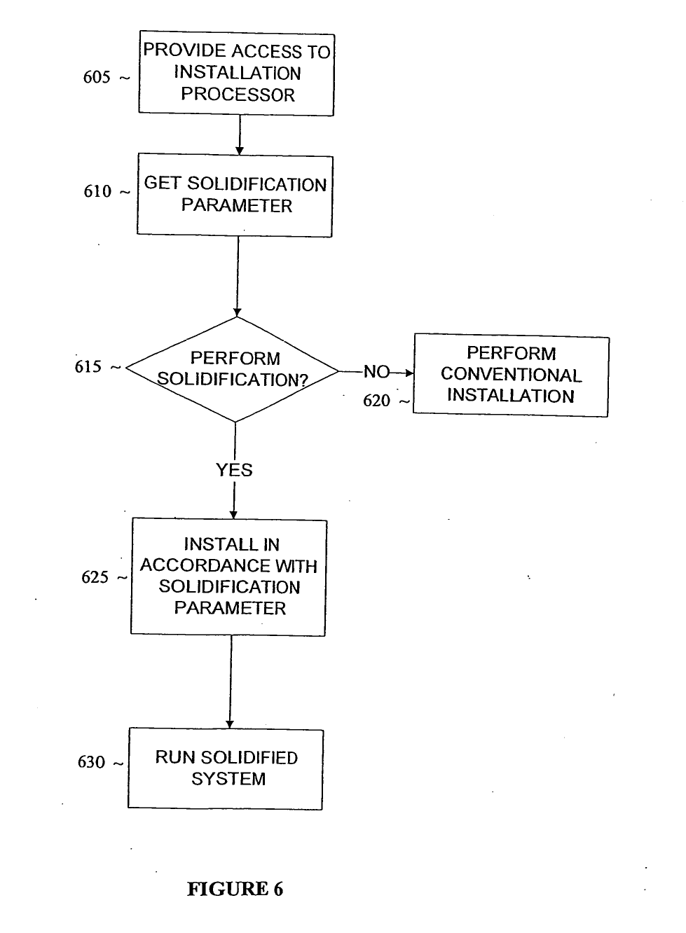

FIG. 6 is a flow chart illustrating a method for performing solidification as part of an installation procedure, according to an embodiment of the present invention. A method for installing software on a computer, comprises the steps of providing access to an installation processor, selecting at least one solidification parameter, wherein the solidification parameter determines a granularity of solidification of the installed software; and installing the software in accordance with the solidification parameter. Interfaces in the software can be independently translated in any number of combinations. The solidification parameter defines which of these interfaces are to be translated. The step of providing access to the installation processor can include providing access to a storage media device containing solidification installation code; and the step of installing the software in accordance with the solidification parameter.

In the case where the computer was built with solidified code, if the installed software is not solidified, it may either be prevented from executing on the computer or be allowed to execute in a restricted way. The restriction would then be lifted once the software is solidified. For previously solidified installed software, the software can be individually solidified for execution on specific devices, or it can be generally solidified for execution on any device. Authentication can be required before access to the solidified software is allowed.

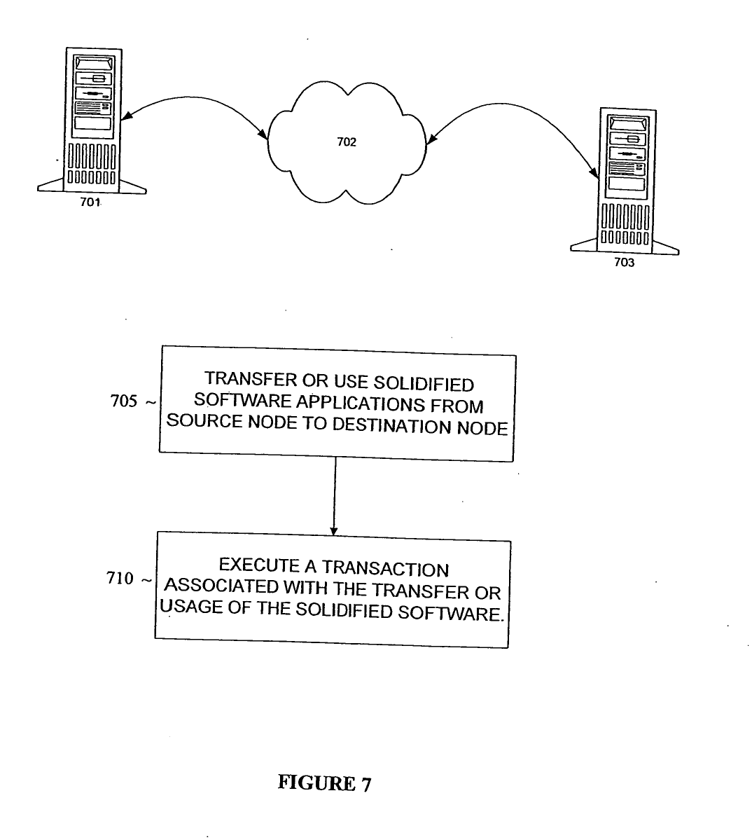

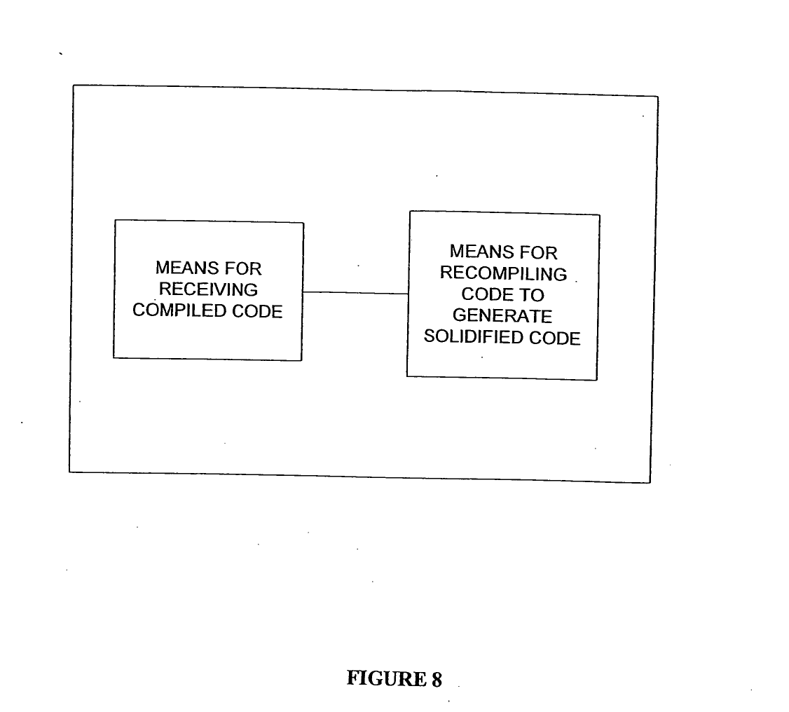

FIG. 7 is a diagram illustrating a business method for distributing solidified software, according to an embodiment of the present invention. On a source node coupled to a destination node in a network, a method for transmitting between the source node and the destination node in the network comprises the steps of transferring from the source node to the destination node, one or more software applications that are solidified, and executing a transaction associated with the transfer or the usage of the solidified software applications. For example, the transaction can be an accounting for a billing amount associated with the transfer or usage of the solidified software applications, wherein the solidified software application provide the creation of a unique computing system by converting uniform systems into functionally equivalent but logically unique systems. The step of sending from the source node to the destination node can include sending from the source node to multiple destination nodes.

FIG. 8 is a block diagram illustrating a compiler used for solidification of compiled code, according to an embodiment of the present invention. An apparatus for compiling software comprises a means for receiving compiled code and a means for recompiling the code to generate solidified code. The recompilation of the code can occur at any point in time after the compiled code is provided to the apparatus, such as during link time or compile time, before or after installation of the compiled code onto a host, before or after execution of the compiled code for a first time on the host, or before or after previously solidified code has been installed or executed on the host.

Foregoing described embodiments of the invention are provided as illustrations and descriptions. They are not intended to limit the invention to precise form described. In particular, it is contemplated that functional implementation of invention described herein may be implemented equivalently in hardware, software, firmware, and/or other available functional components or building blocks, and that networks may be wired, wireless, or a combination of wired and wireless. Other variations and embodiments are possible in light of above teachings, and it is thus intended that the scope of invention not be limited by this Detailed Description, but rather by Claims following.

1. A method of installing software, comprising:
receiving input code, wherein the input code has an original interface;
translating the original interface in accordance with a set of placeholder attributes, wherein the set of placeholder attributes indicates a reference name at a given position in the input code, the reference name taken from a name space of the original interface, wherein the translating includes replacing the reference name with a corresponding translated name in a corresponding translated name space, thereby modifying the input code; and
installing the input code that is modified, wherein a piece of software is rendered un-executable if the piece of software is configured to use the reference name from the name space of the original interface of the input code.

2. The method of claim 1, further comprising operating a system with the interface that is translated.

3. (canceled)

4. (canceled)

5. (canceled)

6. (canceled)

7. (canceled)

8. A manufacturing method of producing one or more storage media devices, comprising:
receiving input code for storage on a media device, wherein the input code has an original interface; and
producing the media device comprising:
translating the original interface in accordance with a set of placeholder attributes, wherein the set of placeholder attributes indicates a reference name at a given position in the input code, the reference name taken from a name space of the original interface, wherein the translating includes replacing the reference name with a corresponding translated name in a corresponding translated name space, thereby modifying the input code, wherein a piece of software is rendered un-executable if the piece of software is configured to use the reference name from the name space of the original interface of the input code; and
copying the input code that is modified to the media device in accordance with predetermined manufacturing criteria,
wherein the media device includes code for the interface that is translated.

9. (canceled)

10. The manufacturing method of claim 8, further comprising:
licensing usage of the produced storage media.

11. The manufacturing method of claim 8, wherein the media device including the code for the interface that is translated according to the placeholder attributes comprises a primary storage device for a processor.

12. A method of installing software on a computer, comprising:
providing access to an installation processor;
selecting software for installation, wherein the software has one or more original interfaces;
selecting a solidification parameter, wherein the solidification parameter defines which of the one or more original interfaces are translated;
translating an original interface of the one or more original interfaces in accordance with the solidification parameter, wherein the software includes a reference name taken from a name space of the original interface, wherein the translating includes replacing the reference name with a corresponding translated name in a corresponding translated name space, thereby translating the software, wherein a piece of software is rendered un-executable if the piece of software is configured to use the reference name from the name space of the original interface of the one or more original interfaces of the software; and
installing the software that is translated in accordance with the solidification parameter.

13. (canceled)

14. The installation method of claim 12, wherein the installing comprises:
loading the software that is translated in accordance with the solidification parameter; and
executing the software that is translated in accordance with the solidification parameter.

15. The installation method of claim 12, wherein the one or more software interfaces are translated before selecting the software for installation.

16. The installation method of claim 15, wherein the one or more software interfaces are translated for a specific device.

17. A method of transmitting software between a source node and a destination node in a network, comprising:
transferring from the source node to the destination node a software application that has a translated interface, wherein the translated interface includes a translated name of a translated name space, wherein the translated name corresponds to a reference name of a name space of an original interface of the software application, wherein the translated replaced the reference name at a given position in the software application,
wherein a piece of software is rendered un-executable if the piece of software is configured to use the reference name from the name space of the original interface of the software application; and
executing a transaction associated with the transfer or a usage of the one or more software applications.

18. The method of claim 17, wherein the executing comprises:
accounting for a billing amount associated with the transfer or usage of the software applications, wherein the software applications provide the creation of a unique computing system by converting uniform systems into functionally equivalent but logically unique systems.

19. The method of claim 17, wherein the transferring comprises:
sending from the source node to a first target destination node; and
sending from the source node to a second target destination node.

20. (canceled)
